(19) United States
(12) Patent Application Publication
(10) Pub. No.: US 2007/0050052 A1
(43) Pub. Date: Mar. 1, 2007

(54) Electronic appliance for and method of using substitutional module thereof

(75) Inventor: Yong Bum Suh, Suwon-Si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-Si (KR)

(21) Appl. No.: 11/493,814

(22) Filed: Jul. 27, 2006

(30) Foreign Application Priority Data
Aug. 26, 2005 (KR) 2005-78735

(51) Int. Cl. G05B 11/01; G05B 19/02

(52) U.S. Cl. 700/23; 340/825.22; 717/174

(57) ABSTRACT

An electronic appliance implementing a method of using a substitutional module includes a specific module, at least one substitutional module which is substitutable for the specific module, a memory which stores control programs respectively prepared for the modules to control the modules, and a controller which checks a system of the electronic appliance during a booting operation of the system, identifies one of the modules which is being operated in the system, based on the results of the checking, reads the control program for the identified module, and controls the identified module in accordance with the read control program.

### CROSS-REFERENCE TO RELATED APPLICATION

This application claims the benefit of Korean Patent Application No. 2005-78735, filed on Aug. 26, 2005 in the Korean Intellectual Property Office, the disclosure of which is incorporated herein by reference.

### BACKGROUND OF THE INVENTION

1. Field of the Invention

Aspects of the present invention relate to an electronic appliance and a method of using a substitutional module thereof, and, more particularly, to an electronic appliance which stores not only a control program for a specific module constituting the electronic appliance, but also a control program for a substitutional module substitutable for the specific module, to control the substitutional module using the stored associated control program when the specific module is substituted with the substitutional module, and a method of using the substitutional module.

2. Description of the Related Art

In accordance with the recent advance of technologies in electronic fields, diverse electronic appliances have been developed. Such an electronic appliance mainly includes a microcomputer, and other modules (for example, a tuner of a DVD recorder, an MPEG encoder, etc.). During operation of such an electronic appliance, the microcomputer of the electronic appliance reads control commands stored in a memory, and controls the modules of the electronic appliance based on the read control command, in order to accomplish the intended use of the electronic appliance.

For control of modules constituting the electronic appliance, it is necessary to previously store control commands for the modules in a memory. To this end, control commands for various modules for use in an electronic appliance are stored in a memory after being programmed in a development stage by the manufacturer of the electronic appliance. However, in conventional cases, when it is desired to substitute a specific module of an electronic appliance with a substitutional module in a development stage of the electronic appliance due to inevitable problems such as design variation or costs, there may be a problem in that, if there is no compatibility between the two modules, the control program made for the specific module cannot be used for the substitutional module, so that the development of the electronic appliance must be delayed. That is, the control program made for control of a specific module cannot be used for other modules which have the same function as that of the specific module, but is incompatible with the specific module. In this case, there is a problem in that the development and delivery of the product is delayed because a control program for a substitutional module must be newly made.

### SUMMARY OF THE INVENTION

Aspects of the invention provide an electronic appliance and a method of using a substitutional module thereof which enable substitutional modules to be immediately used when a part of modules constituting the electronic appliance are substituted with the substitutional modules.

In accordance with one aspect of the present invention, an electronic appliance comprises a specific module; at least one substitutional module which is substitutable for the specific module; a memory which stores control programs respectively prepared for the modules to control the modules; and a controller which checks a system of the electronic appliance during a booting operation of the system, identifies one of the modules which is being operated in the system, based on the results of the checking, reads the control program for the identified module, and controls the identified module in accordance with the read control program.

According to an aspect of the present invention, the specific module and the substitutional module are assigned different module address identifications (IDs), respectively.

According to an aspect of the present invention, the controller reads a module address ID set in the system, and identifies the module which is being operated in the system, based on the read module address ID.

In accordance with another aspect of the present invention, a method of using a substitutional module in an electronic appliance comprises: preparing control programs for a specific module and at least one substitutional module substitutable for the specific module, respectively, storing the control programs in a memory; checking a system of the electronic appliance during a booting operation of the system, and identifying one of the modules which is being operated in the system, based on the results of the checking; reading the control program for the identified module from the memory; and controlling the identified module in accordance with the read control program.

According to an aspect of the present invention, the specific module and the substitutional module are assigned different module address identifications (IDs), respectively.

According to an aspect of the present invention, the identification of the module which is being operated in the system is executed by reading a module address ID set in the system during the booting operation.

### BRIEF DESCRIPTION OF THE DRAWINGS

The above objects and/or other features and advantages of the present invention will become more apparent and more readily appreciated after reading the following detailed description when taken in conjunction with the accompanying drawings, in which:

FIG. 1 is a block diagram illustrating an electronic appliance according to an exemplary embodiment of the present invention; and

FIG. 2 is a flow chart illustrating a method of using a substitutional module in an electronic appliance in accordance with an exemplary embodiment of the present invention.

### DETAILED DESCRIPTION OF THE EMBODIMENTS

Embodiments of the present invention will now be described in detail with reference to the accompanying drawings, wherein like reference numerals refer to the like elements throughout. The embodiments are described below in order to explain the present invention by referring to the figures.

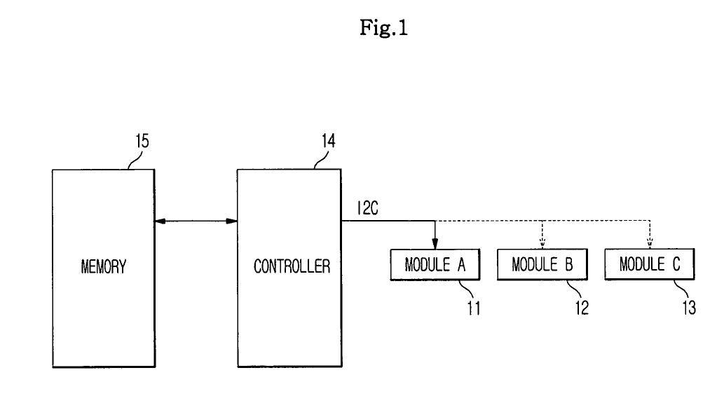

Referring to FIG. 1, an electronic appliance according to an exemplary embodiment of the present invention is illustrated. The electronic appliance includes a specific module 11 which constitutes the electronic appliance, substitutional modules 12 and 13 which are usable in place of the specific module 11, a memory 15 which stores a control program, and a controller 14 which controls the overall operation of the electronic appliance.

The modules 11, 12, and 13 are constituent elements of the electronic appliance to perform various functions in order to accomplish the intended use of the electronic appliance. The modules 11, 12, and 13 may be, for example, a tuner of a DVD (or other like optical recording medium) recorder and/or player, an MPEG (or other like audio and/or video transmission technologies) encoder and/or decoder, and different standards versions (such as for the MPEG or DVD standards). The module 11 is substitutable with one of the substitutional modules 12 and 13. It is understood that, typically, the substitution modules 12, 13 and the module 11 are not included together in the electronic appliance as conceptually shown in FIG. 1, and instead, fewer than all would be included.

The substitutional modules 12 and 13 have the same function as that of the original module 11, and as indicated by the dashed lines, can be used instead of the specific module 11 initially designed to be used as indicated by the solid line. In the case of FIG. 1, the module B 12 and module C 13 are substitutional modules which have the same function as the module A 11 and are substitutable for the module A 11. As such, where the module 11 is compatible with transferring data with respect to a first type of optical recording medium, the module 12 could be compatible with transferring data with respect to first and second types of optical recording medium, and the module 13 could be compatible with only recording data with respect to a first type of optical recording medium such that all have similar functionality. Further, it is understood that the same functionality of the modules 11, 12, 13 can be to convert received data, such that an MPEG type decoder or encoder module 12 could replace a tuner for a DVD recorder module 11. Lastly, it is understood that the modules 11, 12, 13 need not have the same functionality in all aspects of the invention such as when a new functionality is added to the appliance through to replace an old functionality.

The modules 11, 12, and 13 are assigned different address identifications (IDs). Accordingly, it is possible to identify which one of the modules 11, 12, and 13 is being used in a system of the electronic appliance, by reading the module address ID set in the system. The address IDs are values set to identify the modules 11, 12, and 13, namely, different addresses assigned to the modules 11, 12, and 13, respectively. For example, the address IDs of the modules 11, 12, and 13 may be set to addresses 20, 21, and 22, respectively. If the module address ID set in the system is identified to be the address 20 during a system checking operation executed when the electronic appliance is turned on, it can be identified that the module A 11 is being used in the system. However, it is understood that other mechanisms can be used to uniquely identify the modules 11, 12, and 13 so as to identify the corresponding control program for each of the modules 11, 12, and 13.

Control programs for respective modules 11, 12, and 13 are previously stored in the memory 15. That is, in a manufacturing stage of the electronic appliance, the manufacturer of the electronic appliance prepares a control program for a specific module. Additionally, control programs are provided for modules which are substitutable for the specific module, but which are incompatible with the specific module. The prepared control programs are stored in the memory 15. While described as being provided by the manufacturer, it is understood that one or all of the control programs can be otherwise provided or uploaded, such as when the electronic appliance undergoes repairs and/or upgrades.

For example, when it is assumed that the module B 12 is compatible with the module A 11, but the module C 13 is incompatible with the module A, the manufacturer of the module A 11 previously stores in the memory 15 not only a control program for the module A 11, but also a control program for the module C 13 which is incompatible with the module A 11. In this case, accordingly, when the module B 12 is used in place of the module A 11, the module B 12 is controlled using the control program prepared for the module A 11 because the modules 11 and 12 are compatible with each other. However, when the module C 13 is used in place of the module A 11, the module C 13 is controlled using the control program prepared for the module C 13. Of course, if even the module B 12 is incompatible with the module A 11 in the above-described case, a control program for the module B 12 must be additionally stored in the memory 15.

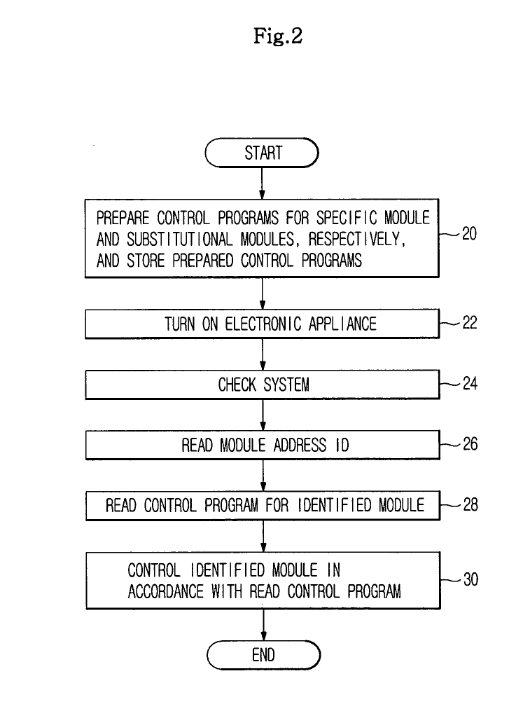

Hereinafter, a method of using a substitutional module in the above-described electronic appliance in accordance with an exemplary embodiment of the present invention will be described with reference to FIG. 2. In accordance with this method, the manufacturer of the electronic appliance previously stores, in a manufacturing stage, not only a control program for the specific module of the electronic appliance, but also a control program for the substitutional module which is incompatible with the specific module, but is substitutable for the specific module, in the memory 15 (20). When the electronic appliance is turned on under the above condition (22), a booting operation is executed, and, simultaneously, the system of the electronic appliance is checked (24). During the system checking, the module address ID set in the system is read through a control bus (shown in FIG. 1 as an I2C bus) connected to the module which is being used (26). However, it is understood that other types of buses can be used instead of or in addition to the I2C bus. Based on the read module address ID, the module which is being used is identified. Moreover, it is understood that the system checking can be performed at other times in addition to or instead of during the booting operation. Further, it is understood that the preparation and storage of the control programs can be performed other than by the manufacturer and at times later than the manufacture stage in other aspects of the invention.

After the module identification, the controller 14 reads the control program for the identified module from the memory 15 (28). For example, when the module which is being used, namely, the identified module, is the module C 13, which is substituted for the specific module A 11, the controller 14 reads the control program for the module C 13 from the memory 15. The controller 14 then analyses the read control program, and controls the identified module 13 in accordance with the analyzed control program (30).

As is apparent from the above description, in accordance with the present invention, not only a control program for a specific module constituting the electronic appliance is stored, but also a control program for a substitutional module substitutable for the specific module is stored, so as to control the substitutional module using the stored associated control program when the specific module is substituted with the substitutional module. Accordingly, it is possible to prevent the development period of the electronic appliance from being extended due to incompletion of the control program for the substitutional module. While not required in all aspects, it is understood that aspects of the invention can be implemented using computer software implemented on at least one computer readable medium readable by one or more computers and/or processors.

Although the embodiments of the invention have been disclosed for illustrative purposes, those skilled in the art will appreciate that various modifications, additions and substitutions are possible, without departing from the scope and spirit of the invention as disclosed in the accompanying claims.

1. An electronic appliance comprising:
a module;
a memory which stores control programs including a specific control program to control a specific module and at least one substitutional control program to control at least one substitutional module which is substitutable for the specific module; and
a controller which checks the electronic appliance during a booting operation for the electronic appliance, identifies the module which is being operated based on the results of the checking, reads the corresponding one of the specific and the at least one substitutional control programs for the identified module, and controls the identified module in accordance with the read one control program.

2. The electronic appliance according to claim 1, wherein:
the specific module and the substitutional module are assigned different module address identifications (IDs); and
the controller reads a module address ID corresponding to the module in the electronic appliance, and identifies the module which is being operated based on the read module address ID.

3. A method of using a substitutional module in an electronic appliance, comprising:
preparing a specific control program for a specific module and a substitutional control program for at least one substitutional module substitutable for the specific module;
storing the prepared control programs in a memory;
checking a system of the electronic appliance during a booting operation of the system;
identifying one of the specific and substitutional modules being operated in the system, based on the results of the checking;
reading from the memory a corresponding one of the specific and substitutional control programs for the identified module; and
controlling the identified module in accordance with the read control program.

4. The method according to claim 3, wherein:
the specific module and the substitutional module are assigned different module address identifications (IDs); and
the identifying further comprises reading a module address ID set in the system during the booting operation.

5. The electronic appliance of claim 1, wherein:
the specific module is not compatible with the at least one substitutional module which is substitutable for the specific module; and
a controller selects one of the specific and the at least one substitutional control programs for the identified module, the selected one control program not being compatible with the non-identified one of the specific and at least one substitutional modules.

6. The electronic appliance of claim 5, wherein:
the specific module is a data translator which translates input data between a first state used for transmission and a second state used for reproducing the input data; and
the at least one substitutional module is another type of data translator not compatible with the specific module.

7. The electronic appliance of claim 6, wherein:
the data translator of the specific module comprises a recorder and/or player;
the data translator of the at least one substitutional module comprises another type of recorder and/or player not compatible with the recorder and/or player of the specific module.

8. The electronic appliance of claim 7, wherein the recorder and/or player is an optical medium recorder and/or player.

9. The electronic appliance of claim 7, wherein the recorder and/or player is DVD compliant.

10. The electronic appliance of claim 6, wherein:
the data translator of the specific module comprises an encoder and/or decoder;
the data translator of the at least one substitutional module is another type of encoder and/or decoder not compatible with the encoder and/or decoder of the specific module.

11. The electronic appliance of claim 10, wherein the encoder and/or decoder is MPEG compliant.

12. The electronic appliance of claim 6, wherein the data translator is MPEG compliant.

13. The method of claim 3, wherein:
the specific module is not compatible with the at least one substitutional module which is substitutable for the specific module; and
reading comprises selecting one of the specific and the at least one substitutional control programs for the identified module, the selected one control program not being compatible with the non-identified one of the specific and at least one substitutional modules.

14. The method of claim 13, wherein:
the specific module is a data translator which translates input data between a first state used for transmission and a second state used for reproducing the input data; and
the at least one substitutional module is another type of data translator not compatible with the specific module.

15. The method of claim 14, wherein:
the data translator of the specific module comprises a recorder and/or player;
the data translator of the at least one substitutional module comprises another type of recorder and/or player not compatible with the specific module.

16. The method of claim 15, wherein the recorder and/or player is an optical medium recorder and/or player.

17. The method of claim 15, wherein the recorder and/or player is DVD compliant.

18. The method of claim 14, wherein:
the data translator of the specific module comprises an encoder and/or decoder;
the data translator of the at least one substitutional module comprises another type of encoder and/or decoder not compatible with the specific module.

19. The method of claim 18, wherein the encoder and/or decoder is MPEG compliant.

20. The method of claim 14, wherein the data translator is MPEG compliant.

21. An electronic appliance comprising:
a module;
a memory which stores control programs including a first control program to control a first module and a second control program to control a second module which is substitutable for and incompatible with the first module; and
a controller which identifies the module which is being operated as being one of the first and second modules, selects from the memory the corresponding one of the first and second control programs for the identified module, and controls the identified module in accordance with the selected one control program.

22. The electronic appliance of claim 21, wherein one of the first and second modules is not used in the electronic appliance.

23. The electronic appliance of claim 21, wherein one of the first and second modules is compliant with an MPEG standard.

24. The electronic appliance of claim 21, wherein one of the first and second modules is compliant with an optical recording medium standard.

25. (canceled)

26. A method of using a module in an electronic appliance, comprising:
identifying which one of first and second modules is being operated as the module in the electronic appliance, the first module being substitutable for and incompatible with the second module;
selecting from a memory a corresponding one of first and second control programs for the identified module, the memory storing the first control program to control the first module and the second control program to control the second module; and
controlling the identified module in accordance with the selected control program.

27. The method of claim 26, wherein one of the first and second modules is not used in the electronic appliance.

28. The method of claim 28, wherein one of the first and second modules is compliant with an MPEG standard.

29. The method of claim 26, wherein one of the first and second modules is compliant with an optical recording medium standard.

30. (canceled)
